(19) United States
(12) Patent Application Publication
(10) Pub. No.: US 2024/0134221 A1
(43) Pub. Date: Apr. 25, 2024

(54) METHOD FOR MANUFACTURING ELECTRONIC DEVICE

(71) Applicant: InnoLux Corporation, Miao-Li County (TW)

(72) Inventors: Li-Chi LO, Miao-Li County (TW); Po-Yu HUANG, Miao-Li County (TW)

(21) Appl. No.: 18/401,873

(22) Filed: Jan. 2, 2024

Related U.S. Application Data
(63) Continuation of application No. 17/501,450, filed on Oct. 14, 2021.

(30) Foreign Application Priority Data
Nov. 23, 2020 (CN) 202011317363.X

(51) Int. Cl. G02F 1/1333

(52) U.S. Cl. CPC G02F 1/133302; G02F 1/133308; G02F 1/133331; G02F 1/13338

(57) ABSTRACT

A method for manufacturing an electronic device is provided. The method includes the following steps: providing a first sub-substrate; providing a second sub-substrate; forming an organic layer between the first sub-substrate and the second sub-substrate, wherein the first sub-substrate and the second sub-substrate are fixed by the organic layer to form a protective substrate; performing a polishing process on a side surface of the protective substrate so that a surface roughness of the side surface is greater than or equal to 1 micrometer and less than or equal to 15 micrometers; and adhering the protective substrate to a frame.

### CROSS REFERENCE TO RELATED APPLICATIONS

This application is a Continuation of U.S. application Ser. No. 17/501,450, filed Oct. 14, 2021, which claims the benefit of China Application No. 202011317363.X, filed Nov. 23, 2020, the entirety of which is incorporated by reference herein.

### BACKGROUND

### Technical Field

The present disclosure is related to an electronic device and a manufacturing method thereof, and in particular it is related to an electronic device having a protective substrate and a manufacturing method thereof.

### Description of the Related Art

Electronic products equipped with display panels, such as tablet computers, notebook computers, smartphones, displays, and televisions, have become indispensable necessities in modern society.

Electronic devices have been widely used in various spaces and environments, and meeting the requirements for safety has become a top concern. Therefore, further improvement of the safety of such electronic devices is still one of the current research topics in the industry.

### SUMMARY

In accordance with some embodiments of the present disclosure, a method for manufacturing an electronic device is provided. The method includes the following steps: providing a first sub-substrate; providing a second sub-substrate; forming an organic layer between the first sub-substrate and the second sub-substrate, wherein the first sub-substrate and the second sub-substrate are fixed by the organic layer to form a protective substrate; performing a polishing process on a side surface of the protective substrate so that a surface roughness of the side surface is greater than or equal to 1 micrometer and less than or equal to 15 micrometers; and adhering the protective substrate to a frame.

A detailed description is given in the following embodiments with reference to the accompanying drawings.

### BRIEF DESCRIPTION OF THE DRAWINGS

The disclosure may be more fully understood by reading the subsequent detailed description and examples with references made to the accompanying drawings, wherein:

FIG. 1 is a schematic side-view diagram of a partial structure of an electronic device in accordance with some embodiments of the present disclosure;

FIG. 2A is a schematic diagram of an enlarged structure of area A in FIG. 1 in accordance with some embodiments of the present disclosure;

FIG. 2B is a schematic diagram of an enlarged structure of area A in FIG. 1 in accordance with some embodiments of the present disclosure;

FIG. 3 is a schematic cross-sectional diagram of an electronic device in accordance with some embodiments of the present disclosure;

FIG. 4 is a flowchart of steps of a method for manufacturing an electronic device in accordance with some embodiments of the present disclosure;

FIG. 5 is the result of a Weibull Analysis performed on a protective substrate of an electronic device in accordance with some embodiments of the present disclosure.

### DETAILED DESCRIPTION

The electronic device and the method for manufacturing the electronic device of the present disclosure are described in detail in the following description. It should be understood that in the following detailed description, for purposes of explanation, numerous specific details and embodiments are set forth in order to provide a thorough understanding of the present disclosure. The elements and configurations described in the following detailed description are set forth in order to clearly describe the present disclosure. These embodiments are used merely for the purpose of illustration and the present disclosure is not limited thereto. In addition, different embodiments may use like and/or corresponding numerals to denote like and/or corresponding elements in order to clearly describe the present disclosure. However, the use of like and/or corresponding numerals of different embodiments does not suggest any correlation between different embodiments.

The present disclosure can be understood by referring to the following detailed description in connection with the accompanying drawings. It should be noted that, for the clarity and the simplicity of the drawings, several drawings in the present disclosure may only depict a part of the electronic device, and the specific elements in the drawings may be not drawn to scale. In addition, the number and size of each element in the drawing are for illustration, and are not intended to limit the scope of the present disclosure.

It should be understood that the elements or devices in the drawings of the present disclosure may be present in any form or configuration known to those skilled in the art. In addition, in the embodiments, relative expressions may be used. For example, “lower”, “bottom”, “higher” or “top” are used to describe the position of one element relative to another. It should be appreciated that if a device is flipped upside down, an element that is “lower” will become an element that is “higher”. The present disclosure can be understood by referring to the following detailed description in connection with the accompanying drawings. The drawings are also regarded as a part of the description of the present disclosure. Moreover, the expressions such as “a first material layer disposed on/over a second material layer”, may indicate the direct contact of the first material layer and the second material layer. Alternatively, it may indicate an indirect contact situation with one or more intermediate layers between the first material layer and the second material layer. In the above situation, the first material layer may not be in direct contact with the second material layer.

Throughout the present disclosure and the appended claims, certain terms are used to refer to specific elements. Those skilled in the art should understand that electronic device manufacturers may refer to the same element with different names. The present disclosure does not intend to distinguish between elements that have the same function but different names. In the specification and claims, the terms “comprising”, “including”, “having” and the like are open-ended phrases, so they should be interpreted as “including but is not limited to . . . ”. Therefore, when the terms “comprising”, “including” and/or “having” are used in the description of the present disclosure, they specify the corresponding features, regions, steps, operations and/or components, but do not exclude the existence of one or more corresponding features, regions, steps, operations and/or components.

Directional terms mentioned in the present disclosure, such as “upper”, “lower”, “front”, “rear”, “left”, “right”, etc., are only the directions referring to the drawings. Therefore, the directional terms are used for illustration, not for limiting the scope of the present disclosure. The drawings depict general features of methods, structures, and/or materials used in particular embodiments. However, these drawings should not be interpreted as defining or limiting the scope or property encompassed by these embodiments. For example, for clarity, the relative sizes, thicknesses, and positions of the various layers, regions, and/or structures may be reduced or enlarged.

In addition, it should be understood that, although the terms “first”, “second”, “third” etc. may be used herein to describe various elements, components, or portions, these elements, components, or portions should not be limited by these terms. These terms are only used to distinguish one element, component, area, layer, or portion from another element, component, area, layer, or portion. Thus, a first element, component, area, layer, or portion discussed below could be termed a second element, component, area, layer, or portion without departing from the teachings of the present disclosure.

The terms “about” and “substantially” typically mean +/−10% of the stated value, or typically +/−5% of the stated value, or typically +/−3% of the stated value, or typically +/−2% of the stated value, or typically +/−1% of the stated value or typically +/−0.5% of the stated value. The stated value of the present disclosure is an approximate value. When there is no specific description, the stated value includes the meaning of “about” or “substantially”. In addition, the term “in a range between the first value and the second value” means that the range includes the first value, the second value, and other values in between.

It should be understood that the following embodiments can replace, recombine, and combine features in several different embodiments to complete other embodiments without departing from the spirit of the present disclosure. The features of the various embodiments can be combined and used arbitrarily as long as they do not violate or conflict the spirit of the present disclosure.

Unless defined otherwise, all technical and scientific terms used herein have the same meaning as commonly understood by one of ordinary skill in the art to which the present disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In accordance with some embodiments of the present disclosure, an electronic device is provided, which includes a protective substrate disposed on a frame, and a side surface of the protective substrate is polished to have a specific surface roughness, thereby improving the impact resistance performance of the protective substrate. In accordance with some embodiments of the present disclosure, the protective substrate can be processed by a chemical strengthening treatment to increase the surface compressive stress of the protective substrate, thereby improving the structural strength or load capacity of the protective substrate.

In accordance with some embodiments of the present disclosure, the electronic device may include a display device, a light-emitting device, a touch device, a sensing device, a tiled device, or a combination thereof, but it is not limited thereto. The electronic device may include a bendable or flexible electronic device. In accordance with some embodiments, the electronic device may include light-emitting diode (LED), liquid crystal, fluorescence, phosphor, quantum dot (QD), another suitable medium, or a combination thereof, but it is not limited thereto. The light-emitting diode may include, for example, an organic light-emitting diode (OLED), an inorganic light-emitting diode, such as a mini light-emitting diode (mini LED), a micro light-emitting diode (micro LED) or a quantum dot light-emitting diode (QLED/QDLED), another suitable material or any combination of the foregoing, but it is not limited thereto. In accordance with some embodiments of the present disclosure, the electronic device can be any arrangement and combination as described above, but the present disclosure is not limited thereto. In addition, the shape of the electronic device may be a rectangle, a circle, a polygon, an irregular shape, a shape with a curved edge, or another suitable shape. In addition to the display panel, the electronic device may also include peripheral systems such as a driving system, a control system, a light source system, or a shelf system to support the display panel. In the following description, a display device will be used as an example to describe the electronic device, but the present disclosure is not limited thereto.

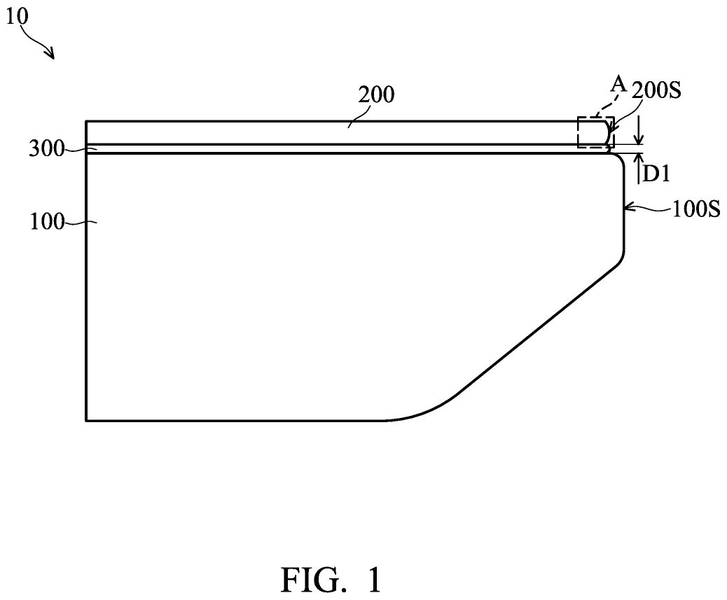

Refer to FIG. 1, which is a schematic side-view diagram of a partial structure of an electronic device 10 in accordance with some embodiments of the present disclosure. It should be understood that, for clear description, some elements of the electronic device 10 are omitted in the drawing, and only some of the elements are schematically shown. In accordance with some embodiments, additional features can be added to the electronic device 10 described below. In accordance with some other embodiments, some of the features of the electronic device 10 described below may be replaced or omitted.

As shown in FIG. 1, the electronic device 10 may include a frame 100 and a protective substrate 200, and the protective substrate 200 may be disposed on the frame 100. In accordance with some embodiments, the electronic device 10 may include an adhesive layer 300 disposed between the protective substrate 200 and the frame 100, and the adhesive layer 300 may adhere the protective substrate 200 to the frame 100. In accordance with some embodiments, the protective substrate 200 may also be used as a touch surface for a user, but it is not limited thereto.

In accordance with some embodiments, the protective substrate 200 and the frame 100 may be separated by a distance D1, and the frame 100 may not extend on a side surface 200S of the protective substrate 200. From the appearance, there is a visual effect of the protective substrate 200 floating on the frame 100. Such a configuration of the protective substrate 200 and the frame 100 is referred to herein as a floating module. In accordance with some embodiments, the side surface 200S of the protective substrate 200 may be not aligned with a side surface 100S of the frame 100. For example, in some embodiments, the side surface 100S of the frame 100 may protrude outward than the side surface 200S of the protective substrate 200, but the present disclosure is not limited thereto. For example, in some embodiments, the side surface 200S of the protective substrate 200 may be aligned with the side surface 100S of the frame 100.

In accordance with some embodiments, the frame 100 can accommodate various components of the electronic device 10 therein. In accordance with some embodiments, the material of the frame 100 may include metal, plastic, ceramic, another suitable material, or a combination thereof, but the present disclosure is not limited thereto.

In accordance with some embodiments, the adhesive layer 300 may include any suitable material with adhesiveness. For example, the adhesive layer 300 may include a light-curable adhesive material, a heat-curable adhesive material, a light-heat-curable adhesive material, an adhesive tape, and another suitable material, or a combination thereof, but it is not limited thereto. In accordance with some embodiments, the adhesive layer 300 may also include an optical clear adhesive (OCA), an optical clear resin (OCR), another suitable material, or a combination thereof, but it is not limited thereto.

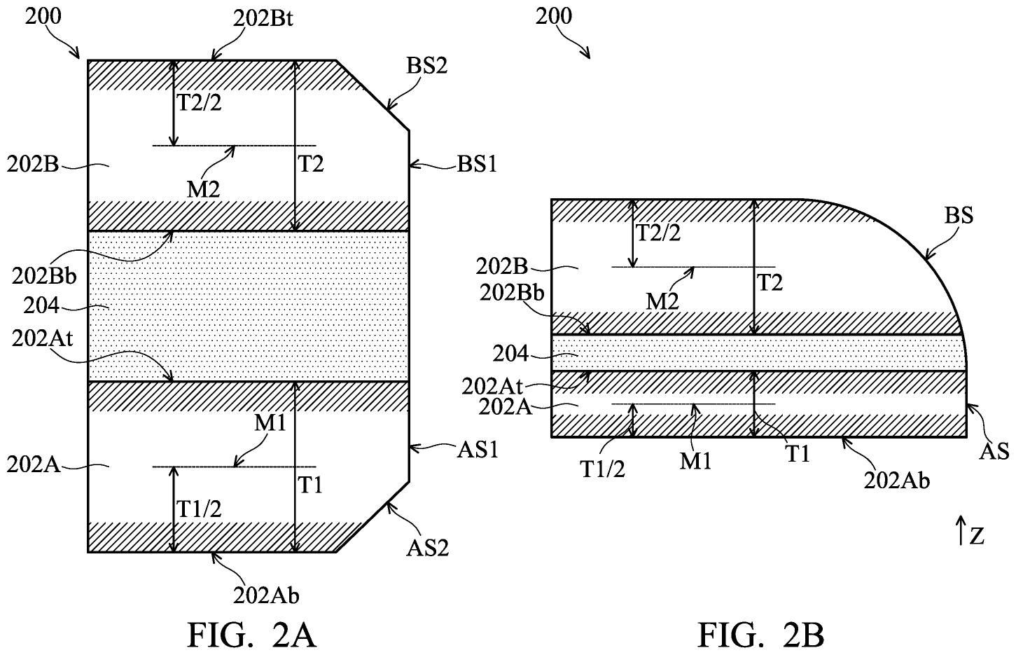

Next, refer to FIG. 2A, which is a schematic diagram of an enlarged structure of area A in FIG. 1 in accordance with some embodiments of the present disclosure. As shown in FIG. 2A, in accordance with some embodiments, the protective substrate 200 may be a composite structure. For example, in accordance with some embodiments, the protective substrate 200 may include a first sub-substrate 202A, a second sub-substrate 202B, and an organic layer 204, and the organic layer 204 may be disposed between the first sub-substrate 202A and the second sub-substrate 202B. In addition, the organic layer 204 may be bonded with the first sub-substrate 202A and the second sub-substrate 202B.

In accordance with some embodiments, the surface roughness of the side surface 200S of the protective substrate 200 may be greater than or equal to 1 micrometer (μm) and less than or equal to 15 micrometers (1 micrometer≤surface roughness≤15 micrometers), or greater than or equal to 1 micrometer and less than or equal to 5 micrometers (1 micrometer≤surface roughness≤5 micrometers), for example, 2 micrometers, 3 micrometers, or 4 micrometers. In accordance with some embodiments, a polishing process may be used to make the side surface 200S of the protective substrate 200 have a specific surface roughness.

The side surface 200S of the aforementioned protective substrate 200 may include the side surface of the first sub-substrate 202A and/or the side surface of the second sub-substrate 202B. Furthermore, in accordance with some embodiments, the side surface 200S of the protective substrate 200 may have a chamfer structure, for example, the chamfer structure may have a turning angle profile. In accordance with some embodiments, the protective substrate 200 may have a C-shaped chamfer, but it is not limited thereto. Specifically, in accordance with some embodiments, the first sub-substrate 202A may have a side surface AS1 and a side surface AS2, and the side surface AS1 may be connected to the side surface AS2. In addition, the slope of the side surface AS1 may be different from the slope of the side surface AS2, and the side surface AS1 and the side surface AS2 may form a chamfered structure. In accordance with some embodiments, the surface roughness of the side surface AS1 and the surface roughness of the side surface AS2 may be greater than or equal to 1 micrometer and less than or equal to 15 micrometers (1 micrometer≤surface roughness≤15 micrometers), or greater than or equal to 1 micrometer and less than or equal to 5 micrometers (1 micrometer≤surface roughness≤5 micrometer). Furthermore, the surface roughness of the side surface AS1 may be the same as or different from the surface roughness of the side surface AS2.

It should be noted that, in the present disclosure, the surface roughness measurement method is to obtain the data or diagram of the surface undulation height along a measurement line (e.g., a section line corresponding to the cross-sectional diagram or a trajectory when the probe is scanned) by an instrument (e.g., a probe-type surface roughness measuring instrument, a white light interferometer, a 3D laser scanners, an optical scanners etc.), and then take an average value of the surface undulation height as a calculation reference line. Then, an average value of the absolute values of the height differences between the undulation height of each position on the surface that is measured and the calculation reference line is referred to as the surface roughness of the surface. In addition, considering that the organic layer 204 is disposed between the first sub-substrate 202A and the second sub-substrate 202B, and the side surface roughness of the organic layer 204 may be relatively large, when calculating the surface roughness of the side surface of the entire protective substrate 200, the side surface of the organic layer 204 should be excluded. In other words, the measurement data of the side surface of the organic layer 204 can be deleted during the measurement, and then the measurement data of the side surfaces of the two sub-substrates can be calculated. Alternatively, after the surface roughness of the first sub-substrate 202A and the second sub-substrate 202B are respectively calculated, the larger one is referred to as the surface roughness of the protective substrate 200. Regardless of the calculation in any of the above methods, the surface roughness of the side surface 200S of the protective substrate 200 according to the present disclosure is greater than or equal to 1 micrometer and less than or equal to 15 micrometers (1 micrometer≤surface roughness≤15 micrometers).

In accordance with some embodiments, the second sub-substrate 202B may have a side surface BS1 and a side surface BS2, and the side surface BS1 may be connected to the side surface BS2. In addition, the slope of the side surface BS1 may be different from the slope of the side surface BS2, and the side surface BS1 and the side surface BS2 may also form a chamfered structure. In accordance with some embodiments, the surface roughness of the side surface BS1 and the surface roughness of the side surface BS2 may be greater than or equal to 1 micrometer and less than or equal to 15 micrometers (1 micrometer≤surface roughness≤15 micrometers), or greater than or equal to 1 micrometer and less than or equal to 5 micrometers (1 micrometer≤surface roughness≤5 micrometer). Furthermore, the surface roughness of the side surface BS1 may be the same as or different from the surface roughness of the side surface BS2.

It should be noted that the side surface with the specific surface roughness as described above can improve the impact resistance performance of the protective substrate 200. When the protective substrate 200 is impacted, the side surface with the specific roughness can control the expansion of the damaged area, for example, to prevent the crack from further extending.

As shown in FIG. 2A, the first sub-substrate 202A may have a first upper surface 202At and a first lower surface 202Ab, and the second sub-substrate 202B may have a second upper surface 202Bt and a second lower surface 202Bb. Specifically, in accordance with some embodiments, the first upper surface 202At, the first lower surface 202Ab, the second upper surface 202Bt, and the second lower surface 202Bb may be processed by a chemical strengthening treatment (as represented by the dash lines in the drawing).

More specifically, in accordance with some embodiments, the compressive stress of the first upper surface 202At and the first lower surface 202Ab that are processed by the chemical strengthening treatment may be greater than the compressive stress of the first sub-substrate 202A located at half of the thickness T1/2 (for example, the position M1 indicated in the drawing). Similarly, in accordance with some embodiments, the compressive stress of the second upper surface 202Bt and the second lower surface 202Bb processed by the chemical strengthening treatment may be greater than the compressive stress of the second sub-substrate 202B located at half of the thickness T2/2 (for example, the position M2 indicated in the drawing). In the present disclosure, the chemical strengthening treatment of ion exchange method may be used, but it is not limited thereto. For example, when potassium nitrate (KNOB) is used for glass strengthening, the sodium ion concentration of the glass will decrease and the potassium ion concentration will increase due to the ion exchange between sodium ions and potassium ions on the glass surface, which increases the compressive stress of the glass surface.

It should be noted that the first sub-substrate 202A and the second sub-substrate 202B that are processed by the chemical strengthening treatment can improve the structural strength or load capacity of the protective substrate 200.

In addition, the first sub-substrate 202A may have a first thickness T1, and the second sub-substrate 202B may have a second thickness T2. In accordance with some embodiments, the first thickness T1 may be greater than or equal to 0.4 millimeters (mm) and less than or equal to 2 millimeters (0.4 millimeters≤first thickness T1≤2 millimeters), for example, 0.9 millimeters or 1.6 millimeters, or greater than or equal to 1 millimeter and less than or equal to 1.5 millimeters (1 millimeter≤first thickness T1≤1.5 millimeters), for example, 1.1 millimeters, 1.2 millimeters, 1.3 millimeters, or 1.4 millimeters. In accordance with some embodiments, the second thickness T2 may be greater than or equal to 0.4 millimeters and less than or equal to 2 millimeters (0.4 millimeters≤second thickness T2≤2 millimeters), or greater than or equal to 0.4 millimeters and less than or equal to 0.7 millimeters (0.4 millimeters≤second thickness T2≤0.7 millimeters), for example, 0.5 millimeters or 0.6 millimeters.

In accordance with some embodiments, the aforementioned first thickness T1 refers to the maximum thickness of the first sub-substrate 202A in a normal direction of the first sub-substrate 202A (for example, the Z direction in the drawing). In accordance with some embodiments, the aforementioned second thickness T2 refers to the maximum thickness of the second sub-substrate 202B in the normal direction of the second sub-substrate 202B.

In accordance with some embodiments of the present disclosure, an optical microscope (OM), a scanning electron microscope (SEM), a film thickness profiler (α-step), an ellipsometer or another suitable method may be used to measure the distance between elements, or the thickness or width of each element. Specifically, in accordance with some embodiments, a scanning electron microscope may be used to obtain any cross-sectional image including the elements to be measured, and the distance between elements, or the thickness or width of each element in the image can be measured.

In accordance with some embodiments, the first sub-substrate 202A and the second sub-substrate 202B may be rigid substrates. Specifically, in accordance with some embodiments, the materials of the first sub-substrate 202A and the second sub-substrate 202B may include a glass material, but it is not limited thereto. In accordance with some embodiments, the glass material may include soda-lime glass, lead glass, borosilicate glass, quartz glass, aluminosilicate glass or another suitable glass material, but it is not limited thereto. Furthermore, the material of the first sub-substrate 202A may be the same as or different from the material of the second sub-substrate 202B.

In accordance with some embodiments, the material of the organic layer 204 may include polyvinyl butyral (PVB), ethylene-vinyl acetate (EVA), polyvinyl alcohol (PVA), ionic intermediate film (SentryGlas® plus, SGP), polyurethane (PU), another suitable organic material, or a combination thereof, but it is not limited thereto.

Next, refer to FIG. 2B, which is a schematic diagram of an enlarged structure of area A in FIG. 1 in accordance with some other embodiments of the present disclosure. It should be understood that the same or similar components or elements in the following context will be denoted by the same or similar reference numbers, and their materials, manufacturing methods and functions are the same or similar to those described above, and thus they will not be repeated in the following context.

As shown in FIG. 2B, in accordance with some embodiments, the chamfered structure of the side surface of the protective substrate 200 may have a curved (smooth) profile. In accordance with some embodiments, the first sub-substrate 202A may a side surface AS, and the surface roughness of the side surface AS may be greater than or equal to 1 micrometer and less than or equal to 15 micrometers (1 micrometer≤surface roughness≤15 micrometers), or greater than or equal to 1 micrometer and less than or equal to 5 micrometers (1 micrometer≤surface roughness≤5 micrometers). Furthermore, in accordance with some embodiments, the second sub-substrate 202B may have a side surface BS, and the surface roughness of the side surface BS may be greater than or equal to 1 micrometer and less than or equal to 15 micrometers (1 micrometer≤surface roughness≤15 micrometers), or greater than or equal to 1 micrometer and less than or equal to 5 micrometers (1 micrometer≤surface roughness≤5 micrometers). Furthermore, the surface roughness of the side surface AS of the first sub-substrate 202A may be the same as or different from the surface roughness of the side surface BS of the second sub-substrate 202B. In addition, in accordance with some embodiments, the radius of curvature of the side surface AS may be the same as or different from the radius of curvature of the side surface BS, or one of the side surface AS and the side surface BS may be not curved, as shown in FIG. 2B.

In addition, in this embodiment, the first thickness T1 may be the same as or different from the second thickness T2. For example, in this embodiment, the first thickness T1 may be greater than or equal to 0.4 millimeters and less than or equal to 2 millimeters (0.4 millimeters≤first thickness T1≤2 millimeters), or greater than or equal to 1 millimeter and less than or equal to 1.5 millimeters (1 millimeter≤first thickness T1≤1.5 millimeters), for example, 1.1 millimeters, 1.2 millimeters, 1.3 millimeters, or 1.4 millimeters. In this embodiment, the second thickness T2 may be greater than or equal to 0.7 millimeters and less than or equal to 1.1 millimeters (0.4 millimeters≤second thickness T2≤1.1 millimeters), for example, 0.5 millimeters, 0.6 millimeters, 0.7 millimeters, 0.8 millimeters, 0.9 millimeters or 1 millimeter.

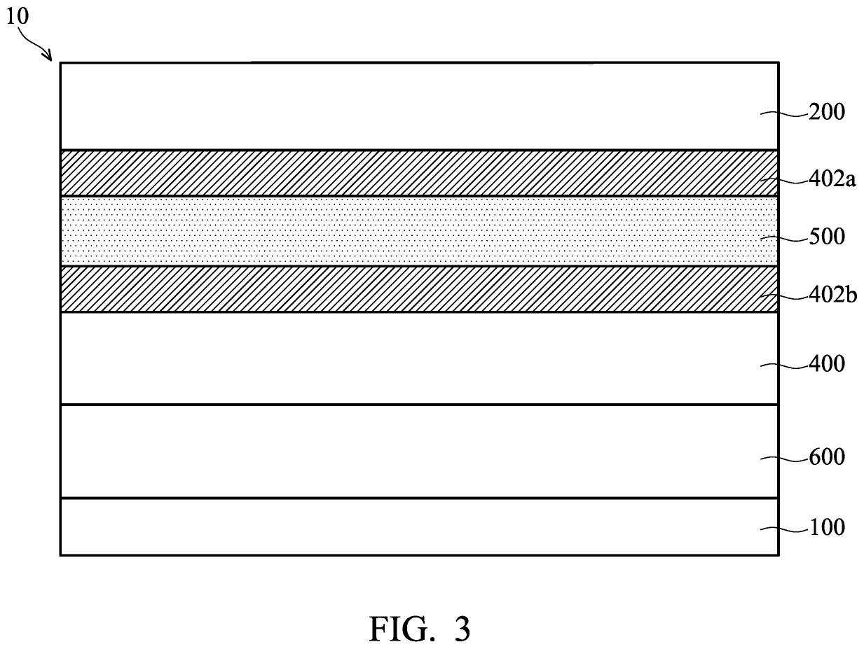

Next, refer to FIG. 3, which is a schematic cross-sectional diagram of the electronic device 10 in accordance with some embodiments of the present disclosure. It should be understood that the adhesive layer 300 of the electronic device 10 is omitted in FIG. 3, and the components contained in the frame 100 are further illustrated in FIG. 3. In accordance with some embodiments, the electronic device 10 may include a display element 400, a sensing element 500 and a backlight module 600. In accordance with some embodiments, the display element 400, the sensing element 500, and the backlight module 600 may be disposed between the protective substrate 200 and the frame 100. Specifically, the display element 400, the sensing element 500, and the backlight module 600 may be disposed in the space defined between the protective substrate 200 and the frame 100. In accordance with some embodiments, the sensing element 500 may be adjacent to the protection substrate 200, and the display element 400 may be disposed between the sensing element 500 and the backlight module 600. However, the relative positional relationship of the sensing element 500, the display element 400, and the backlight module 600 is not limited thereto. For example, in accordance with some embodiments, the sensing element 500 may be disposed between the display element 400 and the backlight module 600.

In accordance with some embodiments, the display element 400 may include a liquid-crystal display, but it is not limited thereto. In accordance with some embodiments, the liquid-crystal display may include a twisted nematic (TN) liquid-crystal panel, a super twisted nematic (STN) liquid-crystal panel, a double layer super twisted nematic (DSTN) liquid-crystal panel, a vertical alignment (VA) liquid-crystal panel, an in-plane switching (IPS) liquid-crystal panel, a cholesteric liquid-crystal panel, a blue phase liquid-crystal panel, a fringe-field switching (FFS) liquid-crystal panel, or another suitable display panel, but the present disclosure is not limited thereto.

In accordance with some embodiments, the display element 400 may further include an alignment film (not illustrated), a light-shielding layer (not illustrated), a prism (not illustrated), a brightness enhancement film (BEF, not illustrated), a light guide plate (not illustrated), a diffuser (not illustrated), a reflector (not illustrated), a quantum dot film (QD film), another suitable component, or a combination thereof, but the present disclosure is not limited thereto.

In accordance with some embodiments, the sensing element 500 may include a touch layer, and the touch layer may include touch electrodes (not illustrated) and wires (not illustrated). In accordance with some embodiments, the materials of the touch electrodes and the wires may include metal materials or transparent conductive materials. For example, the metal material may include copper (Cu), aluminum (Al), indium (in), ruthenium (Ru), tin (Sn), gold (Au), platinum (Pt), zinc (Zn), silver (Ag), titanium (Ti), lead (Pb), nickel (Ni), chromium (Cr), magnesium (Mg), palladium (Pd), alloys of the above metal materials, another suitable material or a combination thereof, but it is not limited thereto. For example, the transparent conductive material may include indium tin oxide (ITO), tin oxide (SnO), zinc oxide (ZnO), indium zinc oxide (IZO), indium gallium zinc oxide (IGZO), indium tin zinc oxide (ITZO), antimony tin oxide (ATO), antimony zinc oxide (AZO), another suitable transparent conductive material or a combination thereof, but it is not limited thereto.

Furthermore, in accordance with some embodiments, the electronic device 10 may further include an adhesive layer 402a and an adhesive layer 402b. The adhesive layer 402a and the adhesive layer 402b may be disposed on both sides of the sensing element 500, and the adhesive layer 402a may be used to adhere the protective substrate 200 and the sensing element 500, and the adhesive layer 402b may be used to adhere the display element 400 and the sensing element 500. The materials of the adhesive layer 402a and the adhesive layer 402b may be the same as or similar to the material of the aforementioned adhesive layer 300, and thus will not be repeated herein.

In addition, the backlight module 600 may provide the light source required by the display element 400. In accordance with some embodiments, the backlight module 600 may include a light-emitting diode (LED), such as a mini light-emitting diode (mini LED), a micro light-emitting diode (micro LED), an organic light-emitting diode (OLED), electroluminescence, another suitable light-emitting element, or a combination thereof, but the present disclosure is not limited thereto.

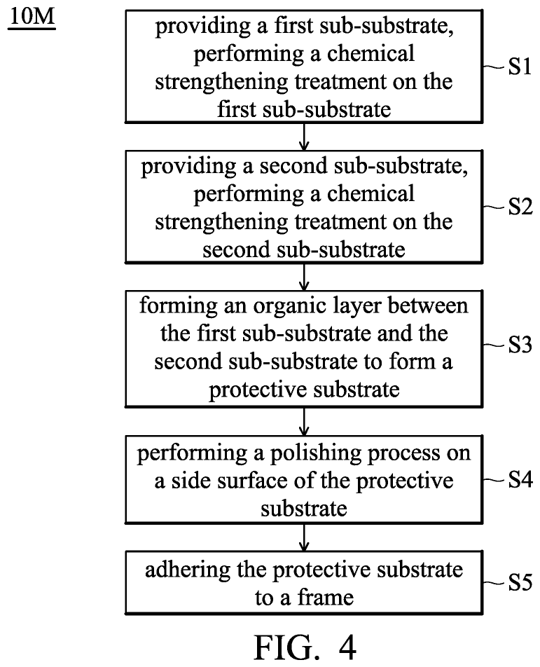

Next, refer to FIG. 4, which is a flowchart of steps of a method 10M for manufacturing an electronic device in accordance with some embodiments of the present disclosure. It should be understood that additional steps may be added before, during, and/or after the manufacturing method of the electronic device, or some steps may be replaced or omitted. In accordance with some embodiments, the electronic device 10 as described above can be formed by the manufacturing method 10M.

As shown in FIG. 4, in accordance with some embodiments, the method 10M for manufacturing the electronic device may include providing a first sub-substrate 202A, performing a chemical strengthening treatment on the first sub-substrate 202A (step S1); and providing a second sub-substrate 202A, performing a chemical strengthening treatment on the second sub-substrate 202B (step S2). In accordance with some embodiments, the chemical strengthening treatment may include an ion exchange treatment, but it is not limited thereto. Specifically, the ion exchange process can replace the alkali metal ions with a smaller ion radius (for example, lithium ion or sodium ion) existing near the surfaces of the first sub-substrate 202A and the second sub-substrate 202B with alkali metal ions with a larger ion radius (for example, compared with lithium ion, the one with a larger ion radius is sodium ion or potassium ion; and compared with sodium ion, the one with a larger ion radius is potassium ion), but it is not limited thereto. In this way, the compressive stress on the surfaces of the first sub-substrate 202A and the second sub-substrate 202B will remain, and the structural strength of the surfaces can be improved. It should be noted that the compressive stress on the surface may at least partly come from the ion exchange treatment. Specifically, when the ions with a smaller radius near the surface of the sub-substrate are replaced by ions with a larger radius, the nearby structures will generate compressive stress due to compression.

In accordance with some embodiments, after the chemical strengthening treatment is performed on the first sub-substrate 202A, a cutting process may be optionally performed on the first sub-substrate 202A so that the first sub-substrate 202A may have a suitable shape, such as a rectangle, circle, polygon, irregular shape, or another suitable shape. In accordance with some embodiments, after the cutting process is performed, a thermal bending process may be optionally performed to bend the first sub-substrate 202A to have a suitable curvature, or to bend the edge of the first sub-substrate 202A. In accordance with some embodiments, the temperature of the thermal bending process may be greater than or equal to 580° C. and less than or equal to 650° C. (580° C.≤temperature of the hot bending process≤650° C.), but it is not limited thereto. Alternatively, in accordance with some other embodiments, the first sub-substrate 202A and the second sub-substrate 202B may be bent in the subsequent step of assembling the first sub-substrate 202A and the second sub-substrate 202B to form a protective substrate 200 having a curved surface.

Furthermore, in accordance with some embodiments, after the chemical strengthening treatment is performed on the second sub-substrate 202B, a cutting process may also be optionally performed on the second sub-substrate 202B so that the second sub-substrate 202B may have a suitable shape, such as a rectangle, circle, polygon, irregular shape, or another suitable shape. In accordance with some embodiments, after the cutting process is performed, a decoration layer (not illustrated) may be optionally formed on the second sub-substrate 202B. In accordance with some embodiments, the decoration layer may include any pattern or logo or the like. In accordance with some embodiments, the decoration layer may be formed by a printing process, a laser process, or another suitable process. Furthermore, in accordance with some embodiments, before or after the decoration layer is formed, a surface treatment may be optionally performed on the second sub-substrate 202B. For example, an anti-glare treatment, an anti-reflection treatment, a hard coating treatment, an anti-electrification treatment, an anti-fouling treatment or the like may be performed.

In accordance with some embodiments, the first sub-substrate 202A and the second sub-substrate 202B then may be assembled. As shown in FIG. 4, forming an organic layer 204 between the first sub-substrate 202A and the second sub-substrate 202B to form a protective substrate 200 (step S3). Specifically, in accordance with some embodiments, the first sub-substrate 202A, the organic layer 204, and the second sub-substrate 202B may be arranged from bottom to top, and then a heating process may be performed so that the organic layer 204 may be attached to the first sub-substrate 202A and the second sub-substrate 202B. In accordance with some embodiments, the temperature of the heating process may be greater than or equal to 120° C. and less than or equal to 140° C. (120° C.≤temperature of the heating process≤140° C.), but it is not limited thereto.

In addition, as described above, in accordance with some embodiments, the first sub-substrate 202A and the second sub-substrate 202B may be simultaneously bent in step S3 to form the protective substrate 200 having a curved surface. Specifically, in accordance with some embodiments, the first sub-substrate 202A and the second sub-substrate 202B may have a curved profile by using a jig with a suitable shape in combination with the aforementioned heating process.

Next, in accordance with some embodiments, performing a polishing process on a side surface of the protective substrate 200 (step S4). After the polishing process is performed, the surface roughness of the side surface of the protective substrate 200 may be greater than or equal to 1 micrometer and less than or equal to 15 micrometers (1 micrometer≤surface roughness≤15 micrometers). In addition, in accordance with some embodiments, before the polishing process is performed on the side surface of the protective substrate 200, a grinding process may be optionally performed on the side surface of the protective substrate 200 first, but the present disclosure is not limited thereto.

In accordance with some embodiments, adhering the protective substrate 200 to a frame 100 (step S5). Specifically, in accordance with some embodiments, after the side surface of the protective substrate 200 is polished, the protective substrate 200 may be assembled with a sensing element 500, a display element 400 and so on. For example, the protective substrate 200 and the sensing element 500 may be fixed using an adhesive layer 402a, and the protective substrate 200 and the display element 400 may be fixed using an adhesive layer 402b. After that, the display element 400 and a backlight module 600 may be assembled to complete the electronic device 10.

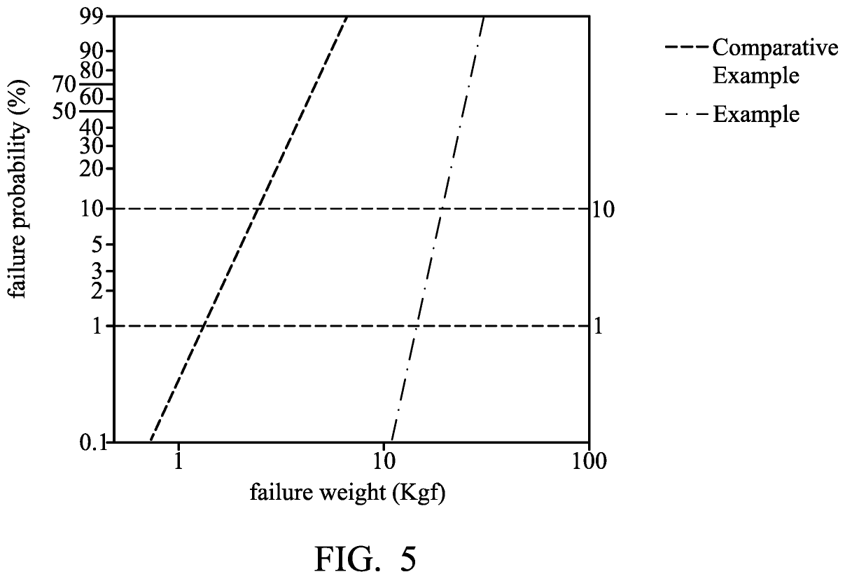

Refer to FIG. 5, which is the result of a Weibull Analysis performed on the protective substrate 200 of the electronic device in accordance with some embodiments of the present disclosure. Specifically, in the analysis, a thrust tester instrument may be used to measure the amount of thrust that the edge of the protective substrate 200 can withstand, so as to evaluate the probability that the protective substrate 200 may fail during human operation. The relevant settings of the instrument were as follows: the loading speed was 5 millimeter/minute, the material of the pressing wheel was polymethylmetacrylate (PMMA), the thickness of the pressing wheel was 1 millimeter, and the diameter of the pressing wheel was 16 millimeters. During the test, the force applied by the pressing wheel to the protective substrate 200 gradually increased until the protective substrate 200 was broken. The data obtained in the test were analyzed using a Weibull Analysis, and the relationship between failure weight and failure probability shown in FIG. 5 was obtained. It should be noted that the various parameters of the settings and the material and size of the pressing wheel described in the above test are merely an example, and the present disclosure is not limited thereto.

As shown in FIG. 5, the Example in the figure (right line) represents the test result of the protective substrate 200 whose side surface has been processed by the polishing process and the chemical strengthening treatment. The Comparative Example (left line) represents the test result of the protective substrate 200 that has not been processed by the polishing process and the chemical strengthening treatment. According to the results shown in FIG. 5, it can be seen that under the same weight, the failure probability (i.e. the substrate is cracked) of the Example is significantly lower than that of the Comparative Example. In other words, under the same failure probability, the weight that the Example can withstand is significantly greater than that of the Comparative Example. Accordingly, it can be seen that even when the edge of the protective substrate is pressed or knocked hard, the probability of cracking or damage to the protective substrate is reduced.

To summarize the above, in accordance with some embodiments of the present disclosure, the side surface of the protective substrate of the electronic device is polished to have a specific surface roughness, thereby improving the impact resistance performance of the protective substrate. Furthermore, the protective substrate can be processed by a chemical strengthening treatment to increase the surface compressive stress of the protective substrate, thereby improving the structural strength or load capacity of the protective substrate. Therefore, the safety of the electronic device applicable to various environments (for example, indoor, outdoor, or in-vehicle environments) can be improved.

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims. Any embodiment or claim of the present disclosure does not need to meet all the purposes, advantages, and features disclosed in the present disclosure.

What is claimed is:

1. A method for manufacturing an electronic device, comprising:
providing a first sub-substrate;
providing a second sub-substrate;
forming an organic layer between the first sub-substrate and the second sub-substrate, wherein the first sub-substrate and the second sub-substrate are fixed by the organic layer to form a protective substrate;
performing a polishing process on a side surface of the protective substrate so that a surface roughness of the side surface is greater than or equal to 1 micrometer and less than or equal to 15 micrometers; and
adhering the protective substrate to a frame.

2. The method for manufacturing an electronic device as claimed in claim 1, further comprising:
performing a chemical strengthening treatment on a first upper surface and a first lower surface of the first sub-substrate; and
performing a chemical strengthening treatment on a second upper surface and a second lower surface of the second sub-substrate.

3. The method for manufacturing an electronic device as claimed in claim 1, after performing the chemical strengthening treatment, further comprising:
performing a cutting process on the first sub-substrate; and
performing a thermal bending process to bend the first sub-substrate.

4. The method for manufacturing an electronic device as claimed in claim 3, wherein a temperature of the thermal bending process is greater than or equal to 580° C. and less than or equal to 650° C.

5. The method for manufacturing an electronic device as claimed in claim 1, further comprising:
performing a heating process so that the organic layer is attached to the first sub-substrate and the second sub-substrate, wherein a temperature of the heating process is greater than or equal to 120° C. and less than or equal to 140° C.

6. The method for manufacturing an electronic device as claimed in claim 5, wherein the first sub-substrate and the second sub-substrate are bent during the heating process to form the protective substrate having a curved surface.

7. The method for manufacturing an electronic device as claimed in claim 1, further comprising:
performing a grinding process on the side surface of the protective substrate before performing the polishing process.

8. The method for manufacturing an electronic device as claimed in claim 1, wherein a failure weight of the protective substrate is greater than 10 Kgf.

9. The method for manufacturing an electronic device as claimed in claim 1, wherein the first sub-substrate has a first side surface and a second side surface, the first side surface is connected to the second side surface, the first side surface and the second side surface form a chamfered structure, and a slope of the first side surface is different from a slope of the second side surface.

10. The method for manufacturing an electronic device as claimed in claim 1, wherein the second sub-substrate has a first side surface and a second side surface, the first side surface is connected to the second side surface, the first side surface and the second side surface form a chamfered structure, and a slope of the first side surface is different from a slope of the second side surface.
